(19) United States
(12) Patent Application Publication
(10) Pub. No.: US 2008/0298254 A1
(43) Pub. Date: Dec. 4, 2008

(54) Time-Slotted Protocol With Arming

(76) Inventor: John C. Eidson, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/757,206

(22) Filed: Jun. 1, 2007

(51) Int. Cl. H04J 1/16

(52) U.S. Cl. 370/241

(57) ABSTRACT

The method augments the time-slotted protocols with additional features that allow arming functions to be implemented as an inherent part of the protocol.

### BACKGROUND

The use of time-slotted communication protocols is common in industrial automation to enforce a regular and predictable time behavior on a system, e.g. Profibus, TTP, and SERCOS. In the general computing field, similar characteristics are found in TDMA or TDMA-like protocols, e.g. IEEE 1394 (Firewire). The demands of safety critical systems also require the use of such protocols, e.g. ARINC.

These protocols assign different devices or alternatively different functions specific time-slots in a TDMA fashion. Since each device or function has a pre-assigned time-slot during which it is guaranteed uncontested access to the communication, the delivery of information can be planned and predictable. The only additional requirement to ensure predictable behavior is that all nodes be able to process the information within the allotted time so that they are free to deal with information that may appear in the next time slot.

Such protocols work very well in systems with regular, generally periodic, behavior. This is true of most industrial applications that are highly repetitive in nature or for which the control strategy can be accomplished with predictable periodic updates.

These are variants on time-slotted protocols in which one time-slot is allocated for “general” traffic that is governed by some other contention resolution means. Common examples include proposals for time-slotted Ethernet communication. During the time-slot designated for general Ethernet traffic, the usual Ethernet contention rules apply. The other time-slots are assigned to specific devices or functions. In principle, such proposals allow implementing critical systems on Ethernet using the assigned slots while allowing the more general model of communication to be used for non-critical activities, at the cost of special hardware to enforce this protocol.

Neither the pure time-slotted nor the variant described are optimal for systems that are required to deal with truly asynchronous events in real-time. Unfortunately, this is exactly the situation in many test and measurement applications. The difficulty is that unless the event is detected by a device within the time-slot allocated to the device, there is an unavoidable latency of the entire length of the TDMA protocol before the event notification can reach other nodes in the system.

### SUMMARY

A test and measurement system includes a time-slotted protocol having an arming state machine. The arming state machine includes armed and trigger states devoted to asynchronous events. Transitions into and out of the armed states are based on time-base execution. The time-slotted protocol reserves communications bandwidth for handling asynchronous events. The test and measurement system may also include client activities, e.g. process and devices, have responses to the arming state machine.

### BRIEF DESCRIPTION OF THE DRAWINGS

FIG. 1 illustrates a state machine of the present invention.

### DETAILED DESCRIPTION

The invention is directed towards augmenting the usual time-slotted protocols with additional features that allow arming functions to be implemented as an inherent part of the protocol. To facilitate understanding, the augmented protocol is termed an “armed-time-slotted protocol” (ATSP) henceforth.

Arming is a technique commonly used internal to test instruments to discriminate which of potentially many trigger events (often present as electrical signals) are accepted and allowed to cause action. Arming is normally specified as a state machine in which entrance to the armed state is itself caused by one or more events, signals, or conditions.

In the present solution, the arming concept is broadened to include not only instruments and devices but also the communication system itself. In the communication system, this can be done by incorporating arming into a time-slotted protocol or a time-slotted protocol that used the variant for general unassigned traffic described earlier. This method is applicable to test and measurement as the asynchronous events of interest typically occur during well defined intervals of the test procedures. During these periods of interest, normal communications will be suspended, perhaps with some qualifications, allowing the network bandwidth to be reserved for handling the asynchronous event traffic. This requires other activities to suspend or at least to postpone the use of the network. This clearly sets a limit on the duration of the armed behavior. Components, devices, and services that use such an environment should be designed with these interruptions in mind. To illustrate, the clock synchronization protocol IEEE-1588 when properly implemented is tolerant of missed network traffic for short periods of time, e.g. a few seconds or fractions of a second, without undue degradation of the time base.

The ATSP includes the following features:
Pre-assigned and determined time slots to be used in the conventional manner to organize periodic or uniform traffic load communications of the system.
Optionally, the variant in which one time-slot is pre-assigned to the function of allowing general first come-first served network traffic (and of necessity no delivery time assurance) used in the conventional manner.
Built-in functionality to suspend the normal operation of the protocol for a period defined by the arming protocol. During this period, only designated activities are permitted to transmit network traffic thus allowing the network to be reserved during times when asynchronous events are an issue.
Optional built-in functionality that allows the arming to be restricted to a portion of the network topology.
To the extent that the signals, events, or conditions that cause a system to enter the armed state require network communications, these communications will occur within the context of the unarmed protocol, i.e. within a time-slot or during the variant period. Thus, there will be a latency associated with the arming actions not experienced by the triggering actions.
   All nodes in the system that share the communication network must participate in the ATSP for it to work.

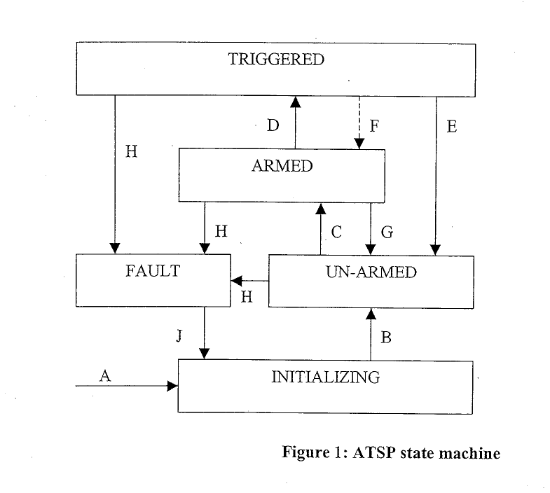

Each node will support an ATSP state as illustrated in FIG. 1. At startup or at similar times, the ATSP protocol is initialized in all nodes by transitioning, transition A, into the INITIALIZATION state. In this state, the time-slots are setup and activated and assignments of devices or functions to the time-slots are made. Typically, the time-slot implementation starts since these often take time to be established in a stable fashion. The time-slots often are implemented using a token-passing scheme, or more commonly based time specifications relative to a system wide time base established by a clock synchronization protocol such as IEEE 1588. During this initialization phase, none of the participating devices are allowed to communicate using their allowed time-slots or the variant slot. Only communication related to initialization is allowed on terms defined by the protocol. Other communications may also be permitted or required to be services, e.g. the clock synchronization protocol used as the basis for establishing time-slots.

At the completion of the initialization process, the nodes transition, transition B, to the UN-ARMED state. This transition can be initiated by a protocol-defined message, can be based on a time relative to the system time base or similar techniques. In the UN-ARMED state, nodes conduct their normal operation using the time-slots as designed and assigned.

The transition, transition C, to the ARMED state is typically initiated by using applications via a network message or based on the system time base. The use of a time-based mechanism for this transition is particularly helpful in that within some temporal guard-band the state machines of all participating nodes transition at the same time. In the ARMED state, the network communications are restricted to communications associated with the expected but asynchronous event(s). Typically, these events are detected by a single, or more uncommonly, by one of multiple devices, which then have assured access to the network. It is good practice to provide a return to normal operation transition G, in the event that the asynchronous event does not occur within some application specific time of interest after arming.

The occurrence of an asynchronous event when in the ARMED state causes a transition to the TRIGGERED state via transition D. In the TRIGGERED state, whatever triggering activities required by the application that used the network are conducted. Depending on the application, the state machine either returns to the ARMED state via transition F for handling additional asynchronous events, or more commonly to the UNARMED state via transition E to allow return to the normal time-slotted communication behavior. Whether the protocol returns to the time-slot active when the arming took place or to some other slot can be an option built into the protocol.

Allowance for protocol faults is provided from all states to a FAULT state via transition H with the customary return to normal operation via transition J and a full or partial re-initialization.

If the underlying network infrastructure permits, it is possible to restrict the arming process to only certain portions of the network. This requires that at the edges of these exceptional regions of arming that inbound network traffic is blocked, discarded, or queued. For example, this could be implemented by special switches or routers that implemented ATSP on a port-by-port basis. These exceptional regions could be defined based on topology, i.e. spatially, or if the communication system is a concurrent operating multiplex such as FDMA by arming only a single element, e.g. frequency.

The approximate temporal appearance of a portion of the network implementing ATSP is illustrated in FIG. 1. In addition to communications, other types of client behavior can make use of the time-slots and the arming mechanism. For example, ATSP can be used to signal devices to arm not only the communication protocol but also other internal activities. For test and measurement instruments, this can be used to cause the measurement front-ends to enter the armed state.

I claim:

1. A system comprising:
a communication system; and
a time-slotted protocol having an arming state machine, operational within the communication system.

2. A system as in claim 1, wherein the arming state machine includes armed and trigger states devoted to asynchronous events.

3. A system as in claim 2, wherein transition into and out of the armed states are based on time-base execution.

4. A system as in claim 1, wherein:
the communication system is a test and measurement system; and
the time-slotted protocol reserves communications bandwidth for handling asynchronous events.

5. A system as in claim 1, comprising:
client activities have responses to the arming state machine.

6. A system as in claim 5, wherein the client activities are selected from a group including client processes and devices.
